(19) United States
(12) Patent Application Publication
(10) Pub. No.: US 2002/0119765 A1
(43) Pub. Date: Aug. 29, 2002

(54) Subscriber interface module for mobile telecommunications systems

(76) Inventors: James Aitken, Dublin (IE); Paul Boyden, Dublin (IE)

Correspondence Address: JACOBSON HOLMAN, PROFESSIONAL LIMITED LIABILITY COMPANY, 400 SEVENTH STREET, N. W., WASHINGTON, DC, 20004, US

(21) Appl. No.: 09/995,855

(22) Filed: Nov. 29, 2001

Related U.S. Application Data
(63) Continuation of application No. PCT/IE00/00073, filed on Jun. 1, 2000.

(30) Foreign Application Priority Data
Jun. 1, 1999 (IE) 990454

(51) Int. Cl. H04Q 7/20

(52) U.S. Cl. 455/403; 379/201.02

(57) ABSTRACT

An interface system (1) interacts on one side in a TCP/IP environment with a client application via an API 3. On the other side the system (1) interacts in a mobile network environment with an HLR 4 via a TCAP API 5, a signalling interface unit (6) and an SS7 network (7). It allows subscribers to use functionality such as feature code services in a more comprehensive and versatile manner.

### FIELD OF THE INVENTION

The invention relates to subscriber interfacing with network elements in a mobile network domain.

At present, such network elements have developed to the stage where a good deal of flexible functionality may be provided for subscribe-s. An example is the set of unstructured supplementary service codes (USSD) in a GSM environment or corresponding “feature codes” in an ANSI41 environment. However growth in subscriber use of such functionality has been restricted because of difficulty in remembering the input codes involved and lack of “user friendliness” generally. This problem arises because network operators only allow subscriber access to network elements such as HLRs via the handset for security reasons.

The invention is directed towards addressing this problem.

### SUMMARY OF THE INVENTION

According to the invention, there is provided an interface system comprising:

a request server comprising means for receiving in a subscriber protocol subscriber requests for services on a mobile network element;

a mobile network service provider;

a request controller comprising means for receiving a client request from the request server and for invoking an operation on the network element in response to said request, and for delivering a network element response to the request server; and

means in the request server for transmitting the response to a subscriber in the subscriber protocol.

In one embodiment, the request server comprises means for communicating with a subscriber using a Web server Servlet with IIOP protocol between the request server and the Web server and HTML protocol between the Web server and tie subscriber.

In one embodiment, the request server has an object-orientated structure and comprises an object associated with each network element service.

Preferably, the request the request server comprises a pool thread object comprising means for routing received requests to appropriate service objects.

In one embodiment, the request server comprises a thread filter object comprising means for filtering requests for the pool thread object.

In another embodiment, the thread filter and the pool thread objects comprises means for allowing concurrent connections to subscribers.

Preferably, the request controller comprises a MAP User connected to a MAP service provider for connection to an SS7 network.

In one embodiment, the MAP User comprises a message router and a dialogue manager, the message router comprising means for interfacing with the MAP service provider, and the dialogue manager comprising means for sending MAP messages for transfer to the MAP service provider.

In a further embodiment, the dialogue manager comprises means for assigning resources to handle a MAP dialogue for each subscriber request and for maintaining a dialogue with the network element until the request has been resolved.

In one embodiment, the dialogue manager comprises means for recognizing trigger messages as indicating that a new dialogue.

In a further embodiment, the dialogue manager comprises means for managing a MAP-based dialogue associated with each of a plurality of different types of trigger message.

In another embodiment, the MAP User has an interface with the request server for receiving requests, said interface comprises mean for providing request services.

In a further embodiment, a service is a registration service to register required information for a request.

In a further embodiment, a service is an erasure service to erase information associated with a request.

In one embodiment, a service is an activation service to activate a request and subsequent invocation of an operation on the network element, and another service is a deactivation service to deactivate the request.

Preferably, a service is an interrogation service to query the status of a request.

In one embodiment, a service is a register password service to change subscriber security codes.

In another embodiment, the request controller comprises means for invoking an operation on a mobile network HLR.

In a further embodiment, the request controller comprises mean for invoking an operation associated with feature or supplementary services such as call barring, call forwarding, or call waiting.

According to another aspect, the invention provides a method for subscriber interfacing with a network element, the method comprising the steps of:

transmitting a subscriber request in a subscriber protocol from a subscriber system to a request server;

the request server delivering said request to a request controller;

the request controller invoking an operation on the network element according to the request; and

the request server delivering a response to the request.

### DETAILED DESCRIPTION OF THE INVENTION

### Brief Description of the Drawings

The invention will be more clearly understood from the following description of some embodiments thereof given by way of example only with reference to the accompanying drawings in which:

FIG. 1 is a high-level schematic representation of an interface system of the invention;

FIG. 2 is diagrammatic representations of the network element services which may be invoked by the interface system;

FIGS. 3 and 4 are diagrams of client architectures;

FIG. 5 is an object model of the system;

FIG. 6 is an object model of a request server;

FIG. 7 is a diagram illustrating system events;

FIG. 8 is a diagram illustrating a MAP User in more detail;

FIG. 9 is a diagram illustrating message routing,

FIG. 10 is a diagram illustrating operation of a dialogue manager;

FIG. 11 is a flow diagram of an SDL procedure for a request;

FIG. 12 is a diagram illustrating MAP User interfaces.

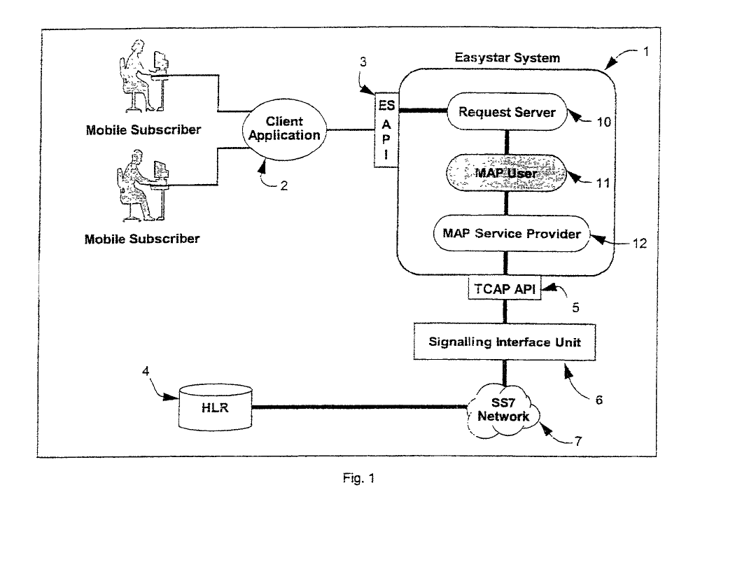

Referring to the drawings, and initially to FIG. 1 an interface system 1 interacts on one side in a TCP/IP environment with a client application 2 via an API 3. On the other side, the system 1 interacts in a mobile network environment with a HLR 4 via a TCAP API 5, a signalling interface unit 6, and an SS7 network 7. The system 1 itself comprises a request server 10, a MAP user 11, and a MAP service provider 12.

In overview, the system 1 receives subscriber requests inputted at a client application 2 and invokes a MAP (Mobile Application Part) operation on the SS7 side for the HLR 4. The system 1 receives the resultant MAP response and generates a client response for viewing by the subscriber. The requests in this embodiment are supplementary service requests such as Call ID (CID), Call Barring (CB), Call Forwarding (CF), and Call Waiting (CW). The request server 10 provides a GUI for access to the services and categories the query and set operations by way of specifying if the action is to affect speech, short messaging, fax, data, or Basic Service Groups. The request server 10 allows clients using the client applications to develop request applications for their model subscribers. It also isolates the remainder of the system 1 and the HLR from unwanted material such as viruses. The request server 10 uses the MAP user to fulfill the received requests.

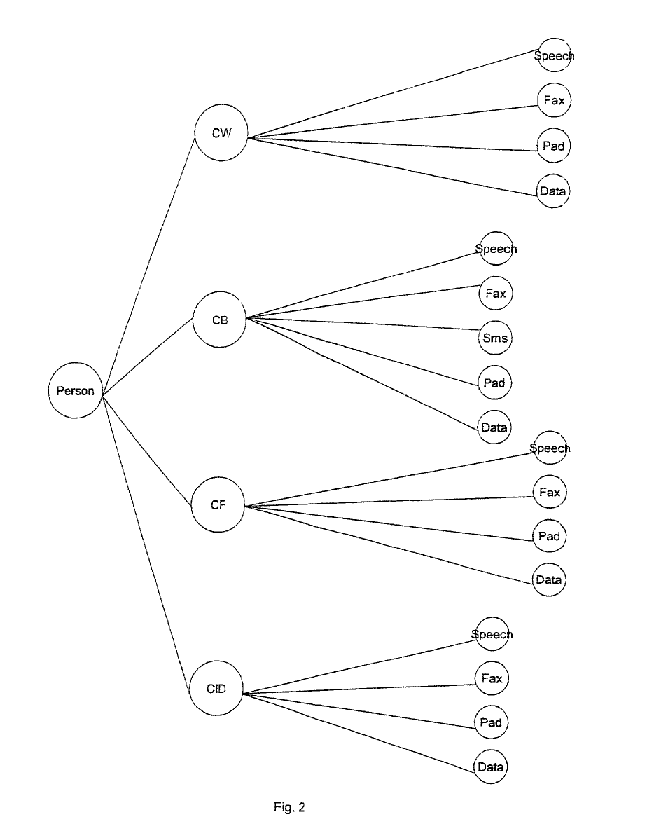

FIG. 2 illustrates a breakdown of the supplementary services which the system 1 handles, and the menu structure presented to subscribers follows this pattern.

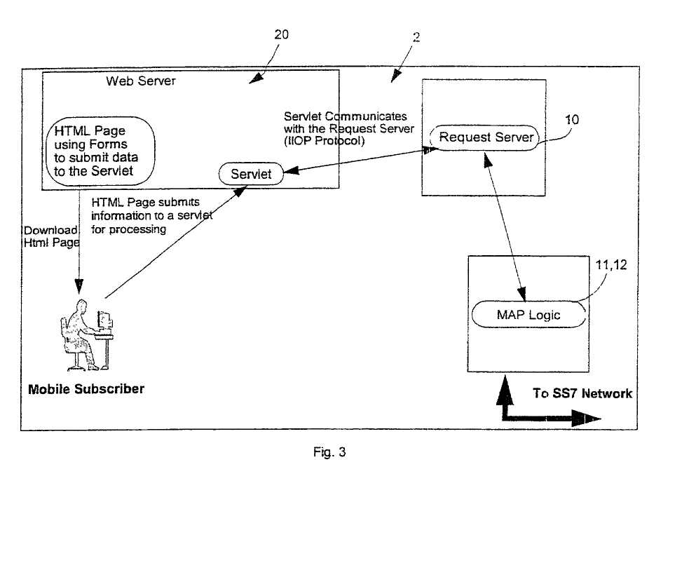

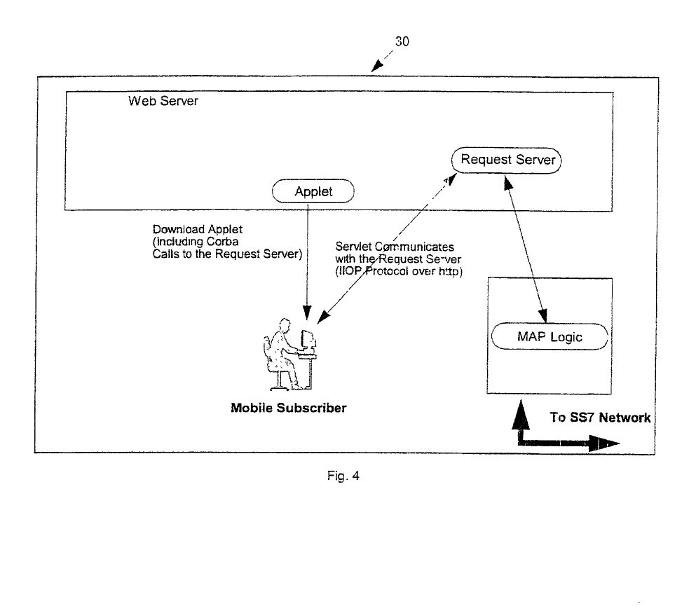

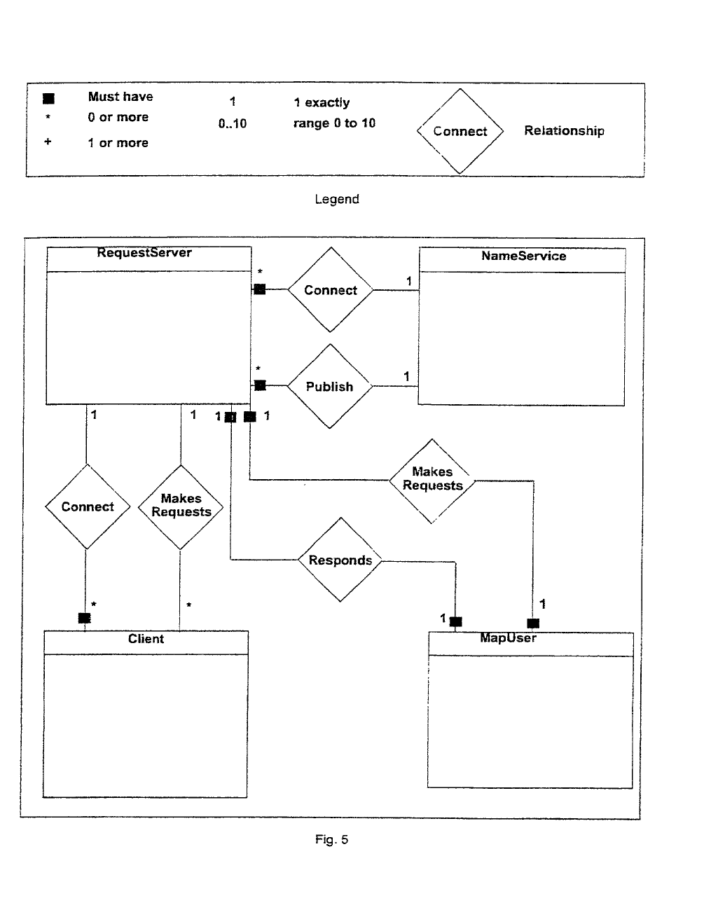

Referring to FIG. 3 the structure of the client application 2 is illustrated. The client application 2 comprises a Web server 20 which provides the subscriber with HTML page forms for submission of data. A Servlet receives submitted information and communicates the request server 10 using the IIOP protocol. An alternative configuration is shown in FIG. 5, in which the request server 10 resides on a Web server 30 which provides the client application functionality. This configuration may only be used within an intranet environment because it is based on a trusted network. An Applet communicates with the request server 10 via IIOP, which is 200 times faster than http. Such an Applet provides a user-friendly GUI. In both embodiments the request server blocks any unwanted data or programs such as viruses. Authentication of the subscriber is performed prior to communication with the request server 10.

The client/request server uses IDL/CORBA functionality and this allows client application development to be independent of the request server architecture. A client application may service one or multiple subscribers and as described above a downloaded Applet may make interface calls directly to the request server, or a HTML page may use a Servlet which makes use of interface calls to the request server 10.

Referring to FIG. 5, an object model of the system 1 is illustrated. There are client, request server, name service, and MAP user objects and the relationships are:

| | |
|---|---|
| client/request server: | connect, make requests |
| request server/name service: | connect, publish |
| request server/MAP User: | make requests, respond |

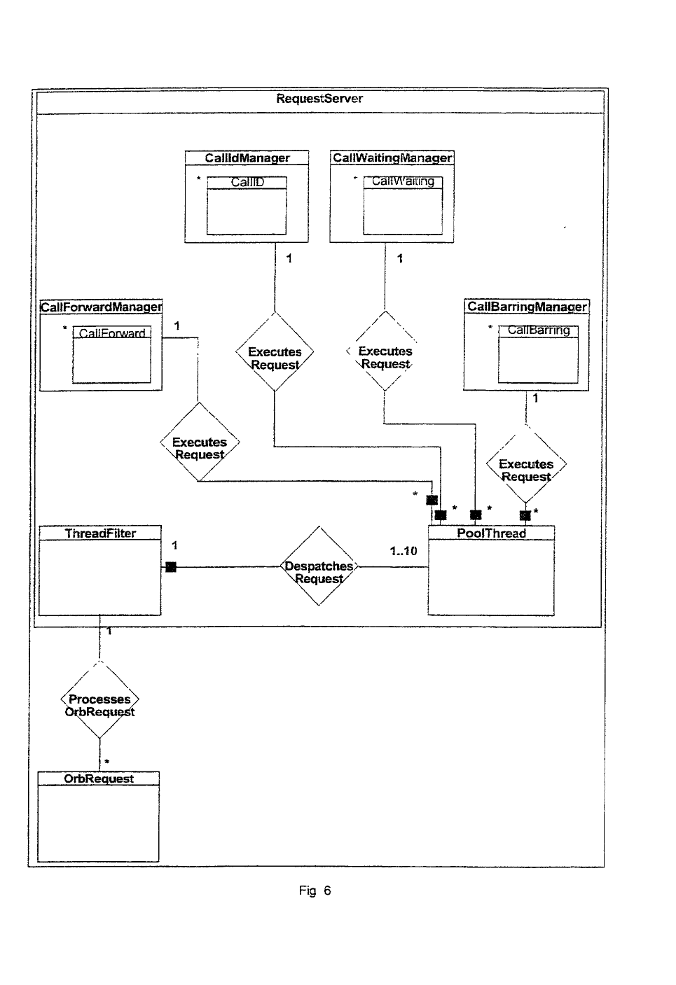

The request server/name service interface is a request server interface, this is now described with reference to FIG. 6. The objects are ThreadFilter, PoolThread, CallBarring Manager, CallWaiting Manger, and CalledManager, and CallForward Manger. Thus, there is an object associated with each service made available to the client. The manager objects create service objects on a per-subscriber basis and the execution of a request on a service object is carried out within the scope of a PoolThread object. The manager objects are indicated as such in their names. In more detail, the following are the object responsibilities:

CallBarringManager—Responsible for creating new Call Barring Objects and disposing of them after a usage timeout value expires.

CallForwardManager—Responsible for creating new Call Forward Objects and disposing of them after a usage timeout value expires.

CalledManager—Responsible for creating new, Call ID Objects and disposing of them after a usage timeout value expires.

CallWaitingManager—Responsible for creating new Call Waiting Objects and disposing of them after a usage timeout value expires.

CallBarring—Each CallBarring Object provides access to query and set methods that allow access to Speech, Fax, Sms, Data and Pad aspects of the CallBarring Service individually or collectively Provides the connection with the Map User and performs simple dialogue to retrieve data.

CallForward—Each CallForward Object provides access to query and set methods that allow access to Speech, Fax, Data and Pad aspects of the CallForward Service individually or collectively. Provides the connection with the Map User and performs simple dialogue to retrieve data.

CallID—Each CallID Object provides access to query and set, methods that allow access to Speech, Fax, Data and Pad aspects of the CallID Service individually or collectively. Provides the connection with the Map User and performs simple dialogue to retrieve data.

CallWaiting—Each CallWaiting Object provides access to query and set methods that allow access to Speech, Fax, Data and Pad aspects of the CallWaiting Service individually or collectively. Provides the connection with the Map User and performs simple dialogue to retrieve data.

PoolThread—Responsible for executing a request within its own thread of execution, to provide concurrent connections to Client Applications.

ThreadFilter—Responsible for accepting OrbRequest Objects and dispatching them to the next available PoolThread.

OrbRequest—CORBA Object received from the Orb, which contains the information that will enable a Client Applications request to be carried out on the Request Server.

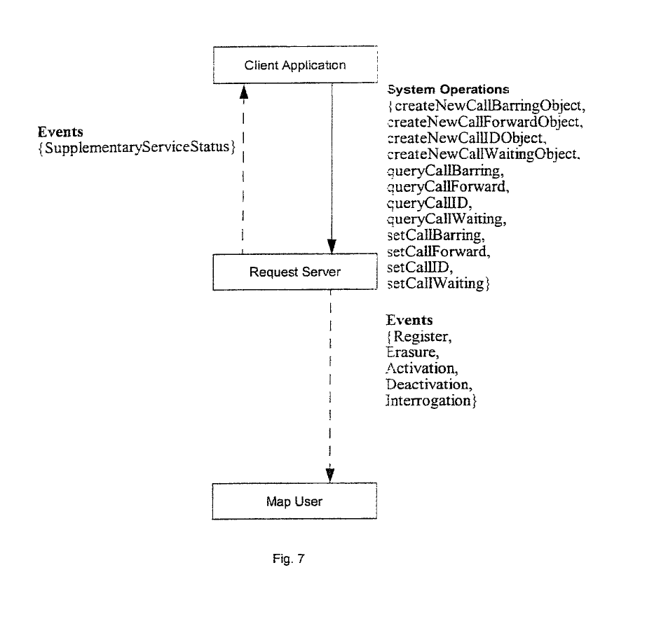

An interface model for the system 1 is shown in FIG. 7. System operations are events that are executed on the request server 10 that cause an event to occur. Events are responses to system operations. The MAP User 11 handles all service requests with the HLR 4 and indeed the HLR does not interface with any other entity. The service provider 12 provides a service based on remote MAP operations by executing the MAP protocol over structured TCAP dialogues with peer entities in the GSM network environment. The signalling interface unit 6 provides the physical connection to the SS7 network.

The duties of the MAP User include:

1. Handling of connections from the Request Server

The MAP User allows multiple connections from the Request Server.

2. Handling of supplementary service requests from the Request Server The MAP User accepts requests from the Request Server once a connection to the Request Server has been established. The requests include the information that is necessary to send the required supplementary service MAP requests to the HLR. After communication with the HLR is complete, the MAP User returns the result to the entity which sent the original request.

3. Connection to the SS7 Network

The MAP User is responsible for all communication with the HLR. The MAP User communicates with the MAP Service Provider to gain access to the SS7 network whereby it can access the supplementary service information stored in the HLR.

4. Handling of MAP-based dialogues to the HLR

The MAP User contains the protocol logic that is used to communicate with a HLR network entity. The protocol logic includes the ability to setup and close MAP-based dialogues with the HLR, issue supplementary service MAP requests to the HLR and receive the responses.

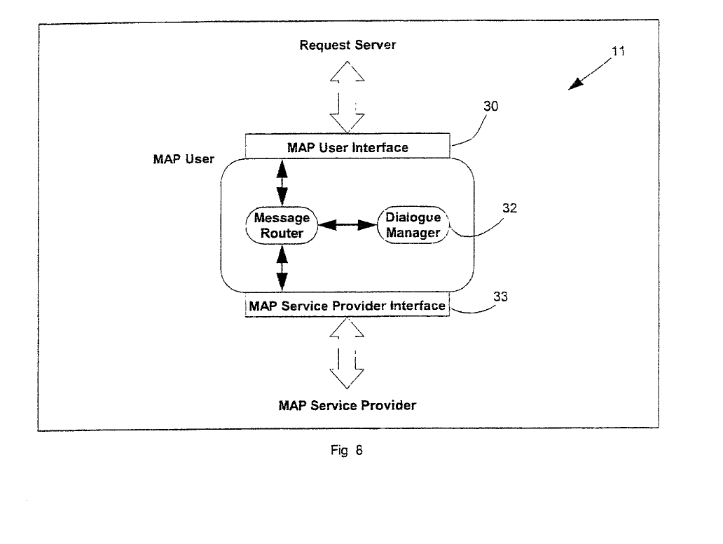

Referring to FIG. 8, the MAP User 11 is an entirely event-driven component and the major functions are:

MAP User interface, 30

Message router 31,

dialogue manager 32, and

MAP Service provider interface 33.

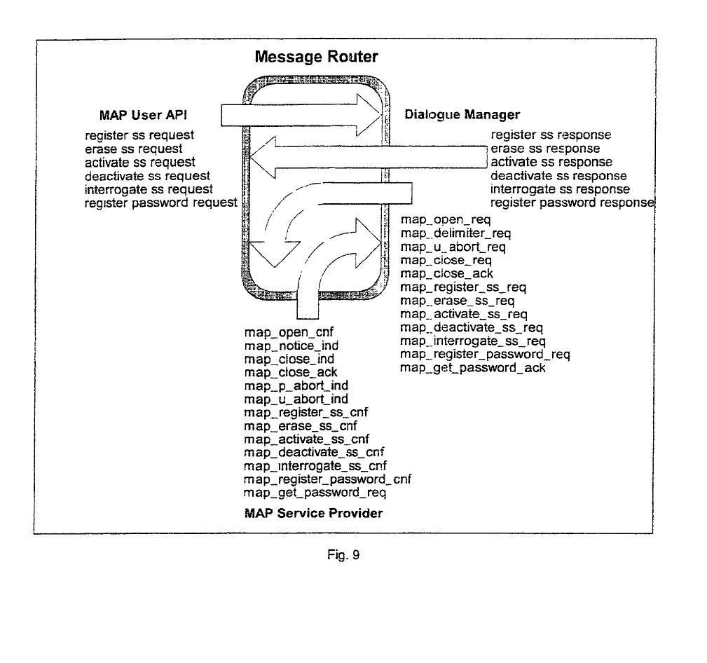

Referring to FIG. 9, the message router 31 is responsible for the transfer of all messages within the MAP User 11 to the correct component. The message router 31 receives and transfers messages from three possible entities.

1. Request Server 10

The message router receives all incoming messages from the Request Server through the MAP User Interface. These messages are new requests from the Request Server so all messages are transferred to the Dialogue Manager for further processing.

2. Dialogue Manager 32

The Dialogue Manager sends MAP messages for transfer to the MAP Service Provider. The dialogue manager also sends result messages to the MAP User API when dialogues are finished.

3. MAP Service Provider 12

The MAP Service Provider sends MAP messages for transfer to the Dialogue Manager.

FIG. 9 illustrates the message routing facility of the MAP User. The diagram shows the three entities under which is given a list of messages which each entity may send. The arrows indicate the destination entity of each message.

The dialogue manager 32 is responsible for assigning resources to handle MAP dialogues with the HLR 4. The dialogue manager receives messages for supplementary service requests. A new Dialogue is assigned to manage each request. Dialogue communication takes place between the HLR until the request has been resolved and the Dialogue Manager returns the response to the entity which originated the request.

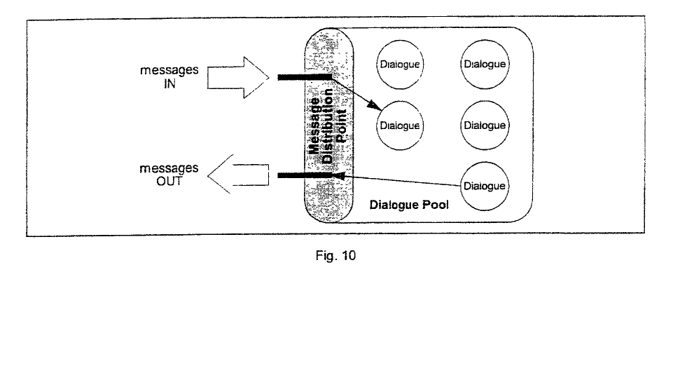

FIG. 10 illustrates the functional components of the dialogue manager 32. It shows the current pool of Dialogues. There are five Dialogues in various stages of communication with the HLR. FIG. 10 also depicts an incoming message being delivered to a Dialogue, while another Dialogue is sending a message to an external entity which could be the MAP Service Provider or the Request Server.

A number of messages have been identified as ‘trigger’ messages within the Dialogue Manager. The receipt of a trigger message indicates that the message is destined for a new Dialogue. The Dialogue Manager must first create a new Dialogue to handle the message. Once the new Dialogue is created, the Dialogue Manager can pass it the message and normal operation resumes.

The following messages have been identified as trigger messages:

register ss request

erase ss request

activate ss request

deactivate ss request

interrogate ss request

register password request

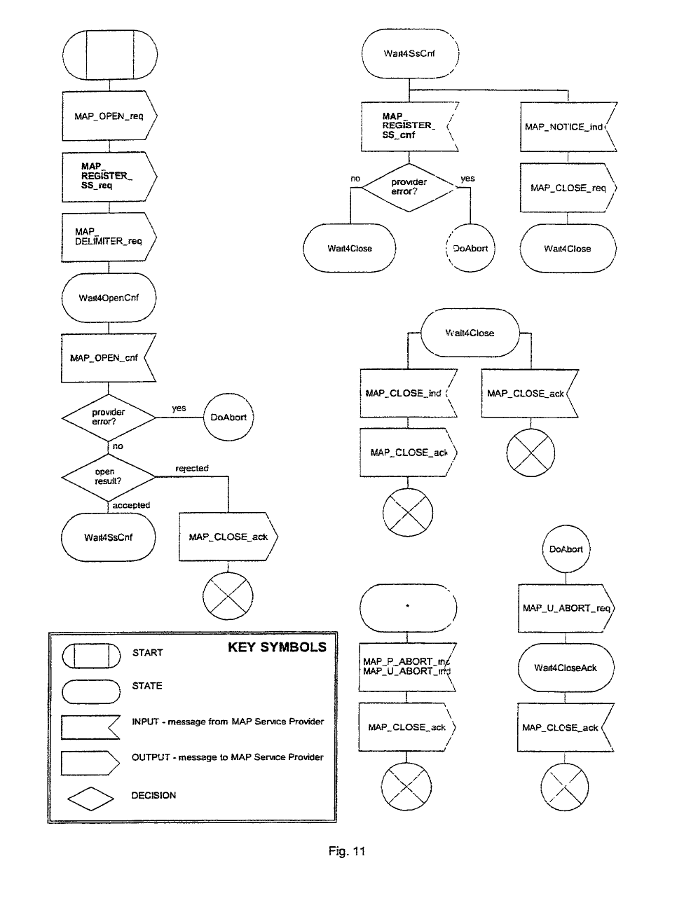

When a new Dialogue is created it initiates a MAP-based dialogue with the HLR. There are six such MAP-based dialogues defined for communicating with the HLR—one for each of the trigger messages. FIG. 11 outlines one such MAP-based procedure. All the procedures take the same format—only the messages defined in bold text change.

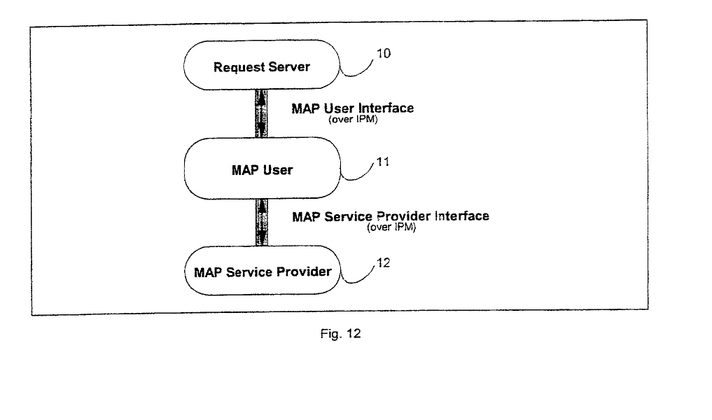

As illustrated in FIG. 12, the communication protocols used by the MAP User 11 are a MAP User Interface with the request server 10, and a MS Service Provider Interface with the MAP Service provider 12.

The MAP User Interface allows the MAP User 11 to be invoked into sending supplementary service requests to the HLR 4. The interface provides a request-response service for each of the supported supplementary service MAP operations. The interface messages provide the necessary information required to build and send MAP messages to the HLR.

The services provided by the interface are:

(a) registration service

(b) erasure service

(c) activation service

(d) deactivation service

(e) interrogation service

(f) register password service

(a) Registration Service

The registration service (a) is used to register information associated with a selected supplementary service. The request and response message parameters are outlined in the following table and explained in further detail below.

| Request parameters | Type | Response parameters | Type |
|---|---|---|---|
| Message ID | Integer | Message ID | Integer |
| | (4 bytes) | | (4 bytes) |
| MSISDN | 15 bytes | Result | 1 byte |
| SS code | 1 byte | | |
| BSG code | 1 byte | | |
| Forward-to-number | 15 bytes | | |
| No-reply timer | 1 byte | | |

Request Parameters

Message ID

This parameter is used to identify the message.

MSISDN

This parameter contains the MSISDN which identifies the mobile subscriber for which the registration request applies to. Each byte stores a character which represents a digit of the MSISDN. The number must be terminated by 0×00. This gives the maximum MSISDN of 14 digits.

SS code

This parameter indicates the supplementary service to be registered. Valid values are obtained by studying <table> and <table> for the register operation.

BSG code

This parameter indicates for which basic service group the given supplementary service is registered. If it is not included, the registration request applies to all basic services.

Valid Values are

0×00 all (speech, sms and fax)

0×10 speech

0×20 sms

0×60 fax

Forward-to number

This parameter contains the MSISDN which represents the forward-to number. The parameter must be present when registration applies to a call forwarding supplementary service. Each byte stores a character which represents a digit of the MSISDN. The number must be terminated by 0×00. This gives the maximum MSISDN of 14 digits.

No-reply timer

This parameter is included if registration applies to the call forwarding on no reply supplementary service (or a superset of this service). The value of this timer is stored in a single byte and must be within the range 5 to 30 (seconds), in steps of 5 (seconds).

Response Parameters

Message ID

This parameter is used to identify the message.

Result

This parameter indicates the success or failure of the registration request.

Valid values are

0 failure

1 success

(b) Erasure Service

The erasure service is used to erase information associated with a selected supplementary service. The request and response message parameters are outlined in the following table and explained in further detail below.

| Request parameters | Type | Response parameters | Type |
|---|---|---|---|
| Message ID | Integer | Message ID | Integer |
| | (4 bytes) | | (4 bytes) |
| MSISDN | 15 bytes | Result | 1 byte |
| SS code | 1 byte | | |
| BSG code | 1 byte | | |

Request Parameters

Message ID

This parameter is used to identify the message.

MSISDN

This parameter contains the MSISDN which identifies the mobile subscriber for which the erasure request applies to. Each byte stores a character which represents a digit of the MSISDN. The number must be terminated by 0×00 . This gives the maximum MSISDN of 14 digits.

SS code

This parameter indicates the supplementary service to be erased. Valid values are obtained by studying <table> and <table> for the erase operation.

BSG code

This parameter indicates for which basic service group the given supplementary service should be erased. If it is not included, the erasure request applies to all basic services.

Valid Values are

0×00 all (speech, sms and fax)

0×10 speech

0×20 sms

0×60 fax

Response Parameters

Message ID

This parameter is used to identify the message.

Result

Indicates success or failure of the request.

Valid Values are

0 failure

1 success

(c) Activation Service

The activation service is used to activate a selected supplementary service. The request and response message parameters are outlined in the following table and explained in further detail below.

| Request parameters | Type | Response parameters | Type |
|---|---|---|---|
| Message ID | Integer | Message ID | Integer |
| | (4 bytes) | | (4 bytes) |
| MSISDN | 15 bytes | Result | 1 byte |
| SS code | 1 byte | | |
| BSG code | 1 byte | | |

Request Parameters

Message ID

This parameter is used to identify the message.

MSISDN

This parameter contains the MSISDN which identifies the mobile subscriber for which the activation request applies to. Each byte stores a character which represents a digit of the MSISDN. The number must be terminated by 0×00 . This gives the maximum MSISDN of 14 digits.

SS code

This parameter indicates the supplementary service to be erased. Valid values are obtained by studying <table> and <table> for the activate operation.

BSG code

This parameter indicates for which basic service group the given supplementary service is activated. If it is not included, the activation request applies to all basic services.

Valid Values are

0×00 all (speech, sms and fax)

0×10 speech

0×20 sms

0×60 fax

Response Parameters

Message ID

This parameter is used to identify the message.

Result

Indicates success or failure of the request.

Valid Values are

0 failure

1 success

(d) Deactivation Service

The deactivation service is used to deactivate a selected supplementary service. The request and response message parameters are outlined in the following table and explained in further detail below.

| Request parameters | Type | Response parameters | Type |
|---|---|---|---|
| Message ID | Integer | Message ID | Integer |
| | (4 bytes) | | (4 bytes) |
| MSISDN | 15 bytes | Result | 1 byte |
| SS code | 1 byte | | |
| BSG code | 1 byte | | |

Request Parameters

Message ID

This parameter is used to identify the message.

MSISDN

This parameter contains the MSISDN which identifies the mobile subscriber for which the deactivation request applies to. Each byte stores a character which represents a digit of the MSISDN. The number must be terminated by 0×00 . This gives the maximum MSISDN of 15 digits.

SS code

This parameter indicates the supplementary service to be erased. Valid values are obtained by studying <table> and <table> for the deactivate operation.

BSG code

This parameter indicates for which basic service group the giver: supplementary service is deactivated. If it is not included, the deactivation request applies to all basic services.

Valid Values are

0×00 all (speech, sms and fax)

0×10 speech

0×20 sms

0×60 fax

Response Parameters

Message ID

This parameter is used to identify the message.

Result

Indicates success or failure of the request.

Valid Values are

0 failure

1 success

(e) Interrogation Service

The interrogation service is used to query the status of selected supplementary service. The request and response message parameters are outlined in the following table and explained in further detail below.

| Request parameters | Type | Response parameters | Type |
|---|---|---|---|
| Message ID | Integer | Message ID | Integer |
| | (4 bytes) | | (4 bytes) |
| MSISDN | 15 bytes | Result | 1 byte |
| SS code | 1 byte | Speech information | 75 bytes |
| BSG code | 1 byte | SMS information | 5 bytes |
| | | Fax information | 75 bytes |

Request Parameters

Message ID

This parameter is used to identify the message.

MSISDN

This parameter contains the MSISDN which identifies the mobile subscriber for which the interrogation request applies to. Each byte stores a character which represents a digit of the MSISDN. The number must be terminated by 0×00. This gives the maximum MSISDN of 14 digits.

SS code

This parameter indicates the supplementary service to be interrogated. Only a single supplementary service may be interrogated per request. Valid values are obtained by studying <table> and <table> for the interrogate operation.

BSG code

This parameter indicates for which basic service group the given supplementary service is interrogated. If it is not included, the interrogation request applies to all basic services.

Valid Values are

0×00 all (speech, sms and fax)

0×10 speech

0×20 sms

0×60 fax

Response Parameters

Message ID

This parameter is used to identify the message.

Result

Indicates success or failure of the request.

Valid Values are

0 failure

1 success

Speech Information

The speech information is structured into three parts. The byte fields explained below are numbered according to the byte position within the response message as a whole. This makes it easier for the developer to locate specific byte fields. The first part contains the status of the supplementary services for speech. This part consists of 14 bytes which are identified as follows:

byte 6: clip status

byte 7: clir status

byte 8: colp status

byte 9: colr status

byte 10: cfu status

byte 1: cfb status

byte 12: cfnry status

byte 13: cfnrc status

byte 14: cw status

byte 15: baoc status

byte 16: boic ex-hc status

byte 17: boic ex-hc status

byte 18: baic status

byte 19: bic-roam status

Each Byte Takes One of the Following Values

0×FF unknown

bit 0 0: not active 1: active

bit 1 0: not registered 1: registered

bit 2 0: not provisioned 1: provisioned

bit 3 0: quiescent 1: operative

The second part contains the forward-to-numbers associated with the speech call forwarding supplementary services. A forward-to-number may be up to 14 digits in length—each digit is stored as a character in a single byte and the number is terminated by 0×00 making the total size of one forward-to-number 15 bytes.

byte 20-34: cfu forward-to-number

byte 35-49: cfb forward-to-number

byte 50-64: cfnry forward-to-number

byte 65-79: cfnrc forward-to-number

The third and final part contains the no-reply timer value associated with the speech call forwarding on no reply supplementary service. The value of the timer is stored in a single byte and must be within the range 5 to 30 (seconds), in steps of 5 (seconds). byte 80: cfnry no-reply timer

SMS information

The sms information consists of only one part. This part contains the status of the supplementary services for sms and consists of 5 bytes which are identified as follows:

The byte fields explained below are numbered according to the byte position within the response message as a whole. This makes it easier for the developer to locate specific byte fields.

byte 81: baoc status

byte 82: boic status

byte 83: boic ex-hc status

byte 84: baic status

byte 85: bic-roam status

Each Byte Takes One of the Following Values

0×FF unknown

bit 0 0: not active 1: active

bit 1 0: not registered 1: registered

bit 2 0: not provisioned 1: provisioned

bit 3 0: quiescent 1: operative

Fax information

The fax information is structured into three parts. The byte fields explained below are numbered according to the byte position within the response message as a whole. This makes it easier for the developer to locate specific byte fields.

The first part contains the status of the supplementary services for fax. This part consists of 14 bytes which are identified as follows:

byte 86: clip status

byte 87: clir status

byte 88: colp status

byte 89: colr status

byte 90: cfu status

byte 91: cfb status

byte 92: cfnry status

byte 93: cfnrc status

byte 94: cw status

byte 95: baoc status

byte 96: boic status

byte 97: boic ex-hc status

byte 98: baic status

byte 99: bic-roam status

Each Byte Takes One of the Following Values

0×FF unknown

bit 0 0: not active 1: active

bit 1 0: not registered 1: registered

bit 2 0: not provisioned 1: provisioned

bit 3 0: quiescent 1: operative

The second part contains the forward-to-numbers associated with the fax call forwarding supplementary services. A forward-to-number may be up to 14 digits in length—each digit is stored as a character in a single byte and the number is terminated by 0×00 making the total size of one forward-to-number 15 bytes.

byte 100-114: cfu forward-to-number

byte 115-129: cfb forward-to-number

byte 130-144: cfnry forward-to-number

byte 145-159: cfnrc forward-to-number

The third and final part contains the no-reply timer value associated with die fax call forwarding on no reply supplementary service. The value of the timer is stored in a single byte and must be within the range 5 to 30 (seconds), in steps of 5 (seconds).

byte 160: cfnry no-reply timer

(f) Register Password Service

The register password service is used to change the PIN associated with selected supplementary services. The request and response message parameters are outlined in the following table and explained in further detail below.

| Request parameters | Type | Response parameters | Type |
|---|---|---|---|
| Message ID | Integer | Message ID | Integer |
| | (4 bytes) | | (4 bytes) |
| MSISDN | 15 bytes | Result | 1 byte |
| SS code | 1 byte | | |
| New password | ? byte | | |

Request Parameters

Message ID

This parameter is used to identify the message.

MSISDN

This parameter contains the MSISDN which identifies the mobile subscriber for which the register password request applies to. Each byte stores a character which represents a digit of the MSISDN. The number must be terminated by 0×00. This gives the maximum MSISDN of 14 digits.

SS code

This parameter indicates for which supplementary service(s) the password should be registered.

New password

This parameter indicates the new PIN.

Response Parameters

Message ED

This parameter is used to identify the message.

Result

Indicates success or failure of the request.

Valid Values are

0 failure

1 success

The MAP Service Provider Interface provides a service based on remote MAP operations to GSM applications. It does this by executing the MAP protocol over structured TCAP dialogues with peer entities in the GSM PLMN.

The MAP User interfaces to the MAP Service Provider by sending and receiving messages over an IPM connection. These messages are defined as part of the MAP-P API. The API is also responsible for setting up the IPM connection, formatting the MAP User messages and transferring them securely over the connection.

The MAP User uses the following MAP-P primitives for MAP dialogue management:

MAP-OPEN

MAP-CLOSE

MAP-NOTICE

MAP-P-ABORT

MAP-U-ABORT

MAP-DELIMIT

The MAP User uses the following MAP-P primitives for MAP supplementary service management:

MAP-REG_SS

MAP-ERASE_SS

MAP-ACTIVATE-SS

MAP-DEACTIVATE-SS

MAP-INTERROGATE-SS

MAP-REGISTER-PASSWORD

MAP-GET-PASSWORD

It will be appreciated that the invention provides for very user-friendly and comprehensive access to a mobile network element. It will broaden the base of subscribers who use features provided by the operators, and the extent of features used. For the operator the invention provides a sate and secure way of providing value-added services in a user-friendly manner.

The invention is not limited to the embodiments described but may be varied in construction and detail.

1. An interface system comprising means for interfacing between a subscriber (2) and a mobile network element (4), in which communication with the subscriber is in a subscriber protocol, characterized in that:
the system comprises a request server (10) for receiving subscriber requests for services on the network element, and for transmitting responses to the subscriber (2);
the system comprises a network service provider (11);
the system comprises a request controller (10) comprising means for:
receiving a client request from the request server (10),
invoking an operation on the network element (4) in response to the client request and using the service provider (12), and
delivering a network element response to the request server (10).

2. An interface system as claimed in claim 1, wherein the request server (10) comprises means for communicating with a subscriber using a Web server (20) Servlet with IIOP protocol between the request server (10) and the Web server (20) and HTML protocol between the Web server and the subscriber.

3. An interface system as claimed in claim 1, wherein the request server (10) has an object-oriented structure (FIG. 2) and comprises an object associated with each network element service.

4. An interface system as claimed in claim 3, wherein the request server (10) comprises a pool thread object comprising means for routing received requests to appropriate service objects.

5. An interface system as claimed in claim 4, wherein the request server comprises a thread filter object comprising means for filtering requests for the pool thread object.

6. An interface system as claimed in claim 5, wherein the thread filter and the pool thread objects comprises means for allowing concurrent connections to subscribers.

7. An interface system as claimed in claim 1, wherein the request controller comprises a MAP User (11) connected to the service provider for connection to an SS7 network, and wherein the service provider is a MAP service provider.

8. An interface system as claimed in claim 7, wherein the MAP User (11) comprises a message router and a dialogue manager, the message router comprising means for interfacing with the MAP service provider (12), and the dialogue manager comprising means for sending MAP messages for transfer to the MAP service provider.

9. An interface system as claimed in claim 8, wherein the dialogue manager comprises means for assigning resources to handle a MAP dialogue for each subscriber request and for maintaining a dialogue with the network element until the request has been resolved.

10. An interface system as claimed in claim 9, wherein the dialogue manager comprises means for recognizing trigger messages as indicating a new dialogue.

11. An interface system as claimed in claim 10, wherein the dialogue manager comprises means for managing a MAP-based dialogue associated with each of a plurality of different types of trigger message.

12. An interface system as claimed in claim 7, wherein the MAP User (11) has an interface with the request server (10) for receiving requests, said interface comprising means for providing request services.

13. An interface system as claimed in claim 12, wherein a service is a registration service to register required information for a request.

14. An interface system as claimed in claim 12, wherein a service is an erasure service to erase information associated with a request.

15. An interface system as claimed in claim 12, wherein a service is an activation service to activate a request and subsequent invocation of an operation on the network element, and another service is a deactivation service to deactivate the request.

16. An interface system as claimed in claim 12, wherein a service is an interrogation service to query the status of a request.

17. An interface system as claimed in claim 12, wherein a service is a register password service to change subscriber security codes.

18. An interface system as claimed in claim 1, wherein the request controller comprises means for invoking an operation on a mobile network HLR.

19. An interface system as claimed in claim 18, wherein the request controller (11) comprises mean for invoking an operation associated with feature or supplementary services such as call barring, call forwarding, or call waiting.

20. A method for subscriber interfacing with a network element, the method comprising the steps of:
transmitting a subscriber request in a subscriber protocol from a subscriber system to a request server;
the request server delivering said request to a request controller;
the request controller invoking an operation on the network element according to the request; and
the request server delivering a response to the request.

21. A computer program product directly loadable into the internal memory of a digital computer and comprising software code portions for performing the steps of claim 20.
